(19) United States
(12) Patent Application Publication
(10) Pub. No.: US 2013/0124394 A1
(43) Pub. Date: May 16, 2013

(54) SYSTEM, METHOD AND ANALYTICAL PREDICTION PROCESS TO GENERATE CONSUMER PERSONALIZED LENDER APPROVAL AND PRICING COMPATIBILITY INFORMATION

(71) Applicant: Matthew E. Takamatsu, Tampa, FL (US)

(72) Inventor: Matthew E. Takamatsu, Tampa, FL (US)

(21) Appl. No.: 13/675,677

(22) Filed: Nov. 13, 2012

Related U.S. Application Data
(60) Provisional application No. 61/560,701, filed on Nov. 16, 2011.

(51) Int. Cl. G06Q 40/02

(52) U.S. Cl. 705/38

(57) ABSTRACT

System and analytical prediction process to generate consumer personalized lender approval and pricing compatibility information is disclosed. The analytic prediction processes applied against historical data from an indiscriminant, autonomous and unaffiliated plurality of lenders is unique and affords consumers numerous advantages over the confusing and incentivized influences associated with the existing systems via an unbiased informational advisory record. Furthermore, the system may make certain information available to consumers that was previously kept private and made confidential by lenders. Consumers may save both time and money through a computer readable medium that identifies and publishes their most cost effective borrowing options, as well as provides guidance on recognizing and procuring equitable interest rates via an analytically derived numerical representation.

This application claims benefit and priority to U.S. Provisional Application No. 61/560,701, filed Nov. 16, 2011, and entitled “SYSTEM, METHOD & ANALYTICAL PREDICTION PROCESS TO GENERATE CONSUMER PERSONALIZED LENDER APPROVAL AND PRICING COMPATIBILITY INFORMATION,” the disclosure of which is incorporated by reference herein in its entirety.

### BACKGROUND

1.0 Field of the Disclosure

The disclosure is directed generally to a consumer personalized lender approval and pricing compatibility processor and, more particularly, to a system and method for providing optimal analysis and decision making for acquiring loans, and the like.

2.0 Related Art

The current lending and borrowing environment includes different complexities that can inhibit consumers from both understanding and identifying the lenders that can provide the most advantageous and equitable interest rates and loan terms consistent with their personal qualifications and borrowing capabilities. This includes the widely utilized practice within and amongst lending institutions of risk based pricing. This practice creates variances between the interest rates and loan terms offered by lenders dependent upon consumers' individual qualifications. Lenders typically do not make this procedure and their parameters privy to consumers. The “secrecy” of these parameters often necessitates borrowers to file multiple applications with numerous lenders or lender affiliates in order to ascertain their prospects and costs associated with each of those lenders. The existing structure is further complicated, unfavorable to and more expensive for consumers as a result of third party origination and referral entities dictating consumers' borrowing options. This structure limits consumers to the defined scope of lenders directly affiliated with the respective origination or referral sources. These entities are, in the vast majority of cases, compensated by lenders, thereby creating an inherent conflict between placing a client with a lender that represents the best interests of the client or a lender that offers a higher compensation level for the referral. Additionally, these types of business relationships provide for an environment ripe for the questionable and unethical practice of “interest rate mark-ups” whereby lenders, often times unbeknownst to consumers, compensate originators or referral sources with additional commissions for selling consumers higher interest rates than they are actually capable of qualifying for.

Existing systems are overly complex and often times prove unfavorable for many consumers. This both sustains and perpetuates an environment where it is difficult for many consumers to realize the true and fullest potential of their individual loan qualifications.

For example, the application of analytic prediction processes against historical data from an indiscriminant and unaffiliated plurality of lenders is unique and allows consumers certain advantages over the confusing and incentivized nature of the existing system via the creation and subsequent delivery to consumers of an individualized and unbiased informational advisory record. This would enable consumers to save both time and money through a computer readable medium that identifies and publishes their most ideal and cost effective borrowing options as well as providing guidance related to recognizing and procuring equitable interest rates via an analytically derived numerical representation.

### SUMMARY OF THE DISCLOSURE

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

In one aspect, a computer implemented method of identifying perspective lenders and their associated pricing is provided. The method may include the steps of acquiring lending data from each of a plurality of lending institutions, scoring the lending data from each of the lending institutions, creating unique data elements that identify predicted risk tolerance and pricing alternatives for each of the plurality of lending institutions, matching qualifications of a consumer to one or more of the data elements; and outputting an advisory that identifies at least one of the plurality of lending institutions matching the qualification of the consumer for identifying a best economical loan, wherein the steps of acquiring, scoring, creating, matching and outputting are performed by a computer. The method may further include the step of creating a consumer borrowing capability data element that is based on credit scores of the consumer and information provided by the consumer for determining that the consumer meets lending parameters of at least one of the plurality of lending institutions. The method may further include the step of establishing that at least two of the plurality of lenders have common attributes so that a data set having the data elements identify and encompass the at least two of the plurality of lenders. The steps of acquiring, scoring, creating, matching and outputting may be performed through a server in network.

In one aspect, a computer program product having storage that stores software, the software being configured to manage loan acquisition, the software when read and executed by a processor being configured to perform the steps of acquiring lending data from different loan/lender data suppliers, scoring the lending data from each of the suppliers, creating unique data elements that identify predicted risk tolerance and pricing alternatives for a plurality of lending institutions, wherein the unique data elements define two or more lenders with common attributes that are analytically scored, matching qualifications of a consumer to one or more data elements, and outputting an advisory that identifies at least one of the plurality of lending institutions matching the qualification of the consumer that identifies a best economical loan, wherein the steps of acquiring, scoring, creating, matching and outputting are performed by a computer. The computer program product may be configured to perform the step of creating a consumer borrowing capabilities that is based on credit scores of the consumer and information provided by the consumer for determining that the consumer meets lending parameters of at least one of the plurality of lending institutions. The computer program product may be configured to perform the step of establishing that at least two of the plurality of lenders have common attributes so that a data set having the data elements identify and encompass the at least two of the plurality of lenders. The computer program product may be configured to perform the step of acquiring lending data from independent sources in addition to the lending institutions and a credit bureau to create the data elements.

In one aspect, a system for managing loan acquisition may include a server configured with decision engine that matches a consumer to a best lender of a plurality of lenders based on borrowing qualifications of the consumer, a database configured to store risk tolerance and pricing alternatives for each of the plurality of lenders accessible by the server, and a storage accessible by the server that stores consumer borrowing qualifications, wherein the decision engine uses the risk tolerance and pricing alternatives of each lender to determine the best lender based on consumer borrowing qualifications. The server may provide a website to interact with a consumer to acquire at least part of the consumer borrowing qualifications. The server may be configured to provide an advisory to a consumer that indicates a best lender based on the borrowing qualifications of the consumer and the risk tolerance and pricing alternatives. The server may be configured to cross tabulate and merge lending data from the plurality of lenders to produce a data set that is matchable to pre-determined borrowing capabilities of the consumer. The data set may encompass at least two lenders of the plurality of lenders having a common attribute.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a functional block diagram of an example process performed according to principles of the disclosure in conjunction with a system, configured according to principles of the disclosure.

The present disclosure is further described in the detailed description that follows.

### DETAILED DESCRIPTION

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. A computer program product may be provided that stores software configured to, when read and executed by a processor, perform one or more steps of the processes described herein.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

Current lending and borrowing environment includes different complexities that may inhibit consumers from both understanding and identifying the lenders that may provide the most advantageous and equitable interest rates and loan terms consistent with their personal qualifications and borrowing capabilities. This may include the widely utilized practice within and amongst lending institutions of risk based pricing. This practice may create variances between the interest rates and loan terms offered by lenders dependent upon consumers' individual qualifications. Lenders typically do not make this procedure and their parameters available to consumers. The “secrecy” of these parameters often necessitates borrowers to file multiple applications with numerous lenders or lender affiliates in order to ascertain their prospects and costs associated with each of those lenders.

The existing structure is further complicated, unfavorable to and more expensive for consumers, as a result of third party origination and referral entities dictating consumers' borrowing options. This structure may limit consumers to the defined scope of lenders directly affiliated with the respective origination or referral service. These entities are, in the vast majority of cases, compensated by lenders, thereby creating an inherent conflict between placing a client with a lender that represents the best interests of the client or a lender that offers a higher compensation level for the referral. Additionally, these types of business relationships provide for an environment ripe for the questionable and unethical practice of “interest rate mark-ups” whereby lenders, often times unbeknownst to consumers, compensate originators or referral services with additional commissions for selling consumers higher interest rates than they are actually capable of qualifying for.

The principles of the disclosure directly address the complexities faced by consumers with the existing lending environment. Through an easy to understand and unbiased advisory record that may publish and rank a subject consumers' most cost effective borrowing outlets, and may publish analytically derived equitable interest rate information based on correlating the subject consumers' individual qualifications to the various costs and loan terms that their similarly qualified peers are receiving. This generated advisory record may afford consumers an economical and time saving advantage when locating and/or negotiating a loan.

By applying a unique analytic prediction process against historical data from an indiscriminant, autonomous and unaffiliated plurality of lenders, and comparing the subsequent data elements to the borrowing qualifications/capabilities of a specific borrower(s), many of the inequities associated with the current market including, but not limited to risk based pricing and interest rate mark-ups can be disintermediated, if not avoided all together, by consumers via an easy to comprehend and unbiased advisory record that may allow consumers to better understand and identify their best borrowing options, e.g. a best economical loan from among a plurality of lenders.

The traditional systems and practices prior to this disclosure often support an inequitable and fixed borrowing environment that is often configured and operated against borrowers and in favor of lenders and their origination and referral services. Such practices like risk based pricing and affiliations between lenders and origination or referral entities can vary and influence the costs and loan terms amongst different consumers. These traditional systems and practices may obscure consumers' realizable interest rates and limits their options to the scope of lenders affiliated with these referral entities and frequently, often unbeknownst to the consumer, causing them to fall prey to questionable practices like interest rate mark-ups. Under the existing traditional system and practices a borrower is typically unaware of the true potential inherent with their personal borrowing qualifications.

The analytic prediction processes applied against historical data from an indiscriminant, autonomous and unaffiliated plurality of lenders is unique and allows consumers numerous advantages over the unfair and biased and incentivized influences associated with the existing system via an unbiased informational advisory record. This allows consumers to save both time and money through a simple medium that identifies and publishes their most cost effective borrowing outlets, as well as provides logical guidance on procuring equitable interest rates. Also, it can produce advisory information, intelligence and educational guidance for consumers and/or businesses in the form of an advisory record.

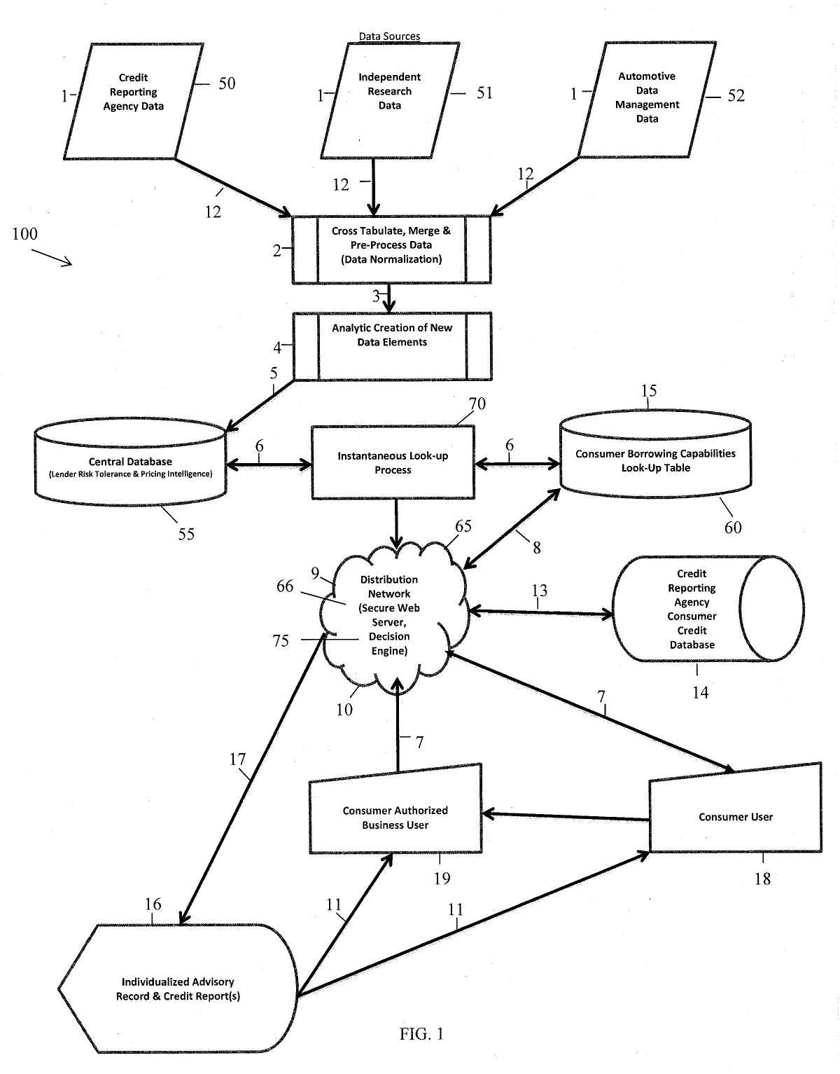

FIG. 1 shows a functional block diagram of an example process performed accorded to principles of the disclosure in conjunction with a system, configured according to principles of the disclosure. FIG. 1 may include the following general steps:
Step 1: Lending data is acquired 12 from various suppliers including National Credit Reporting Agencies 50, Independent Research Firms 51 and/or Dealership Data Management Systems 52.
Step 2: The lending data is merged, cross-tabulated, categorized and processed for validity and viability. (E.g., if certain attributes can establish that lender A can be considered similar to lender B and lender B further show these other characteristics, it may be assumed that data for lender A applies to lender B.) In this way a data set having data elements may be identified that encompasses one or more lenders with common attributes.
Step 3: The intelligence derived from processed data that encompasses one or more lenders with common attributes is ready to be analytically scored to create unique data elements.
Step 4: The lending data is now analytically scored, creating new data elements that identify the predicted risk tolerance and pricing alternatives amongst a plurality of lending institutions (e.g., banks, mortgage companies, credit unions, and the like)
Step 5: This lending data is prepared for mass storage and uploaded to a central database (DB) 55.
Step 6: Lending data stored in the central DB 55 is now ready to be analytically correlated to a consumer borrowing capabilities look-up table 60 (see, also, description related to Decision Engine 75 below). In one aspect, the look-up table 60 may reside in a memory or a database, such as, e.g. DB 55.
Step 7: Consumers 18 and/or third parties with consumers' authorization 19, may initiate the retrieval of an advisory record 16 by creating a consumer borrowing capabilities look-up table 60 via a computer implemented distribution network 65 (which may include a secured web server 66).
Step 8: The consumer borrowing capabilities look-up table 60 is created from applicable information supplied by a subject consumer via the distribution network (65). The subject consumer' credit report(s) may be electronically accessed 13 through a secure gateway connected to the distribution network 65.
Step 9: Relevant loan qualification information and information from credit report(s) may be instantly captured, analytically transformed and uploaded as data for temporary storage in the consumer borrowing capabilities look-up table 60.
Step 10: The data from the consumer borrowing capabilities look-up table 60 may be instantly correlated by a look-up process 70 (which may execute on server 66) to the predictively scored data in the previously generated lending intelligence data located in the central database 55.

Steps 1-6, described above, may illustrate algorithmic computer code to predict and convert historical lender data into valid and viable lender indicative data sets. Steps 7 and 8 may illustrate at least in part human interface elements of the system. Steps 9 and 10 may illustrate, at least in part, substantially instantaneous analytical process where subject consumers are correlated to recommended sets of lenders, as well as furnished equitable interest rate intelligence according to their individual qualifications. The steps described herein may also represent the computer components in combination with a processor to execute the respective steps.

Consumers 18 and/or authorized third parties 19 may initiate the retrieval over communications link 10 of a subject consumer(s) advisory record 16 by accessing our secure web server or computer implemented distribution network 9. Information relevant to a subject consumer(s)' sought after advisory record 16 may be provided via the same communications link 10. A portion of this information also enables the retrieval of the subject consumer(s)' current credit report(s), perhaps via a secure gateway interface 13, accessing a third party's credit information database 14. Other relevant information provided on the subject consumer(s)' qualifications and certain information extracted from their credit report(s) may be uploaded 8 as data, e.g., to a temporary storage medium termed the consumer borrowing capabilities look-up table 15. The data from the consumer borrowing capabilities look up table may be instantaneously matched by process 70 to pre-generated lender intelligence data which may be stored in central database 50 and subsequently an advisory record 16 may be generated 17 and delivered 11 to the consumer 18 or authorized third party 19, as output. The pre-generated intelligence data from the central database 55 may be derived 5 by processing that may include the creation of new predictive data elements 4 that identify the predicted risk tolerance and pricing alternatives amongst a plurality of lending institutions via the application of algorithms 2 to lending data acquired 12 from various direct and/or indirect data sources 50, 51, and/or 52.

According to one principles of the disclosure, the creation of analytical predictors of the risk tolerance and pricing levels may be provided for an indiscriminant, autonomous and unaffiliated plurality of lenders that is derived from their historical lending patterns and pricing. This may include various algorithms involved in pre-processing raw lending data, modeling it for viability and cross tabulating it for categorical classification, then correlating the subsequent data to individual consumers' qualifications and capabilities.

To function at its optimal levels as software as a service (SaaS), the system's individual processes operate in coherence. The system may be configured to provide on-going retrieval of historical data relating to the lending patterns of a plurality of lending institutions, such as banks, mortgage companies, credit unions and the like. Additionally, an on-line communicative relationship with a National Credit Bureau or Credit Information Service may be configured to access consumer's credit files and scores that are utilized in the analytic prediction process. The system 100 and produced advisory record may include personalized loan education and an “if then” credit score/interest rate estimation tool which enables a consumer to understand, firsthand, the impact that any incremental improvement or decline in their credit score might have on their borrowing capabilities.

A secure website 66 may be accessed to provide information related to an authorized consumer's loan qualifications and to secure a copy of a current credit report of a consumer. The consumer, who may be the user, may answer, for example, three to five personal challenge questions to verify their identity. Dependent upon the outcome of the identity authentication, a consumer's credit report may be instantaneously generated. Information from the consumer's credit report, as well as information relevant to the consumer's borrowing capabilities is analyzed to deliver an end output advisory record that accompanies the consumer's credit report. This unbiased advisory record may publish equitable interest rate guidance and may rank the subject consumers' optimal lending options across an indiscriminant, autonomous and unaffiliated plurality of lenders. The information contained in this advisory record empowers its consumers/users to understand, locate and/or negotiate their most equitable and cost effective loan terms. This capability affords numerous advantages over the existing and complex borrowing environment. Furthermore, the advisory record may serve as a constructive and valuable medium in consumer education regarding credit and borrowing decisions.

Also, the advisory may create advisory information, intelligence and educational guidance for consumers and/or businesses in the form of an advisory record.

A system, method and analytic prediction processes described herein may generate consumer personalized loan/lender approval and pricing compatibility information. The information may be displayed in the form of a computer readable unbiased advisory record. The system and process of the disclosure may be based on the analytical prediction of risk tolerance and pricing patterns, as well as other lending parameters amongst an unaffiliated plurality of lenders to non-subjectively correlate their historical lending parameters and pricing to specific consumers' electronically accessed borrowing qualifications/capabilities.

In one aspect, the analytic prediction process, may utilize a storage medium of directly and/or indirectly compiled historical lending data that has been algorithmically processed to predict the risk tolerances and pricing of a plurality of lenders. Furthermore, the analytic prediction process correlates this pre-processed data against information from a consumer borrowing capabilities look-up table to determine whether an individual consumer or group of consumers meets the predicted lending parameters of a lender or group of lenders from the unaffiliated plurality of lenders contained in a storage medium, such as database 55. Based upon the outcome of this process, a recommendation may be provided of the lender(s) that have been projected to most likely approve and/or offer the most competitive pricing and loan terms to the subject consumer(s). In one aspect, the analytical prediction process may incorporate the processing of lender pricing data contained in the storage medium 55 to correlate equitable interest rate data to a subject consumer(s).

The system 100 may electronically access the borrowing capabilities of a subject consumer(s) and may temporarily store data in a look-up table 60. The look-up table data includes, but is not necessarily limited to, the consumer(s)' credit data, credit score, debt-to-income ratio(s), employment status/history and geographical location.

The end output, generated via the system's 100 analytic prediction process, is a computer readable and individualized advisory record publishing the subject consumer(s)' most probable and cost effective lending sources and equitable interest rate direction.

### Example of Using the Principles of the Disclosure

Considering that lender indicative data obtained from a Credit Bureau 50 does not necessarily encompass an entire spectrum of qualification parameters typically employed by most lenders (e.g., automotive lenders, banks, credit unions, and the like), combining, refining and adjusting this Credit Bureau data with the data obtained from an Independent Research Firm 51 may increase reliability of the qualification parameters. This manipulated data creates an entirely new data element that allows for a more accurate estimation of the loan pricing and risk tolerance amongst all of the lenders that credit data, by itself, may not be able to provide.

Part 1: Creating Different Lender Sets with Credit Data:

The different lender sets depend on correlations derived from credit data, and may include factors, for example:

1. Lender type:
a. Bank, Credit Union, Finance Company, Captive, Subprime Finance Company, or the like.

2. Business proclivity
a. Frequency of loans originated over a specified time period, or the like.
b. Frequency of loans in a geographical area or over a specified population scope, or the like.

3. Risk Tolerance
a. Credit score buying range
   i. A minimum score threshold pattern is quantified per lender

4. Geography
a. Scope of lending activity
   i. Identifying a particular lending frequency in city, CBSA, state level, US region or national level, or the like.

Part Two: Match Independent Research and/or Data Management Systems data on lenders to the identical lenders and/or categorically similar lenders (new data elements) from credit data, to expand upon:
New data elements with lenders from credit data may be established by merging lender data from Independent Research Firms and/or Data Management Systems to exact lender data obtained from new credit data sets that categorically match.

For example, ABC Financial Credit Union's Independent Research Firm data is matched with ABC Financial Credit Union's Credit Data.

Independent Research and/or Data Management System data is then matched to all other credit data lenders that are categorically similar to ABC Financial Credit Union and for which Independent Research and/or Data Management System data is not readily available.

Certain scenarios with credit data may be taken into consideration and applied appropriately on a case to case basis. E.g., if there isn't enough data trends (or independent knowledge) with certain lenders in credit data to match in a group or set of other lenders.

Part Three: Depending on the categorization of the lender, an adjuster for the following variables (typically not included with credit data) may be added to a risk based minimum rate estimated from credit data. This allows the appending of estimated lending parameters for the following variables that cannot be analyzed with just credit data, e.g.:

1. New Product

2. Used Product

3. Certified Used Product

4. Age of Used Product

5. Loan-to-Value (LTV) of Product

Part Four: Upload new lender data to mass storage to be accessed by users/consumers through a decision engine, described next.

### Decision Engine

A decision engine 75 may be configured to match a user's qualifications to their best lender according to their individual qualifications, which may be accomplished via a website facilitated at server 66, for example. This process is predicated on obtaining reasonably accurate information from answers to interface questions, to be provided by user/consumer, and from data obtained directly from the user's/consumer's credit report. This process may be formulated directly from the user's/consumer's qualifications where certain lenders are gradually narrowed down based on qualifications and wherein certain qualifications are biased based upon how the user answers various interface questions. This process is described more fully below.

Qualification match to new lender data and lender narrowing process:

1. Employment or Monthly Income
a. Typically is a true/false factor for qualification or disqualification
   i. If user has no source of monthly income than they typically cannot qualify for a loan

2. Debt-to-income (DTI) (monthly)
a. This qualification is derived by adding the open monthly debts from credit report(s) and dividing by total monthly gross income as entered into interface.

3. Geography
a. Identify and select from Local, Regional, National
   i. Rules are applied to compensate for differentiations in geographic locations of the user. E.g. metropolitan or rural

4. Age of Product
a. Derived from user interface questions
   i. Selections are narrowed to data that matches user interface selection (e.g., new, used, or a specified age of product

5. Loan-to Value (LTV)
a. Derived by data analysis to determine and match average LTV data held in central database and applied as influencers dependent upon answers to interface questions.
   i. Influencers (+/− weights to adjust influence)
      1. How do you plan on negotiating the price of your new product? (pull down options)
         a. I usually am willing to pay the retailer full MSRP (new) or listed price (used)
         b. I plan on negotiating a price below MSRP (new) or Listed Price (used)
         c. I plan on negotiating a price around or below invoice (new) or trade-in value (used)
         d. Do you plan on trading in another product? Y/N check box. If Yes, are you trading in a product that is (pull down):
            Paid off
            Worth more than you owe on it
            Worth about what you owe on it
            Worth less than what you owe on it
            Worth substantially less than what you owe on it
      2. What type of down payment do you anticipate making on your product purchase? (pull down options)
         a. I do not anticipate providing a down payment (good credit necessary)
         b. 5% to 10% down payment of product price
         c. 10% to 20% down payment of product price
         d. A down payment more than 20% of product price

6. Credit Score
a. This qualification is derived directly from credit report(s).

Other Factors Related to Decision Engine:

The following additional factors (e.g., Affordability Factor and Business Proclivity) may be considered to implement the decision engine 75 that is configured to impartially match users to their best lender matches. It should however be considered that doing so may narrow the lender pool spectrum to which the user can be matched.

Affordability Factor: this factors a payment derived from the amount selected to finance in the user interface against the user's month income as obtained from the user interface. For example,
i. A pop-up may be implemented when user inputs income (amount financed question precedes income question in interface) that notifies user of this.
   The amount financed question may be moved to later in interface so a pop-up would inform the user of estimated maximum amount qualified for and re-choose from there.
ii. This factor is only typically relevant for subprime borrowers where their affordability is about 25% of their net disposable income. Disposable income is equivalent to taking 25% from gross (taxes) than subtracting all bills (on credit report or utility type (power, cell, etc.) and child support obligations.

Business proclivity: implementation of a suppression rule for lenders if they do not meet a specified frequency, yet conduct business within a population expected to yield a higher amount of business (e.g., the lenders do not show an “appetite” for a specified loan product).

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed is:

1. A computer implemented method of identifying perspective lenders and their associated pricing, the method comprising the steps of:
acquiring lending data from each of a plurality of lending institutions;
scoring the lending data from each of the lending institutions;
creating unique data elements that identify predicted risk tolerance and pricing alternatives for each of the plurality of lending institutions;
matching qualifications of a consumer to one or more of the data elements; and
outputting an advisory that identifies at least one of the plurality of lending institutions matching the qualification of the consumer for identifying a best economical loan,
wherein the steps of acquiring, scoring, creating, matching and outputting are performed by a computer.

2. The computer implemented method of claim 1, further comprising creating a consumer borrowing capability that is based on credit scores of the consumer and information provided by the consumer for determining that the consumer meets lending parameters of at least one of the plurality of lending institutions.

3. The computer implemented method of claim 1, further comprising establishing that at least two of the plurality of lenders have common attributes so that a data set having the data elements identify and encompass the at least two of the plurality of lenders.

4. The computer implemented method of claim 1, wherein the steps of acquiring, scoring, creating, matching and outputting are performed at a server in network.

5. The computer implemented method of claim 1, wherein the unique data elements wherein the unique data elements define two or more lenders with common attributes that are analytically scored.

6. A computer program product having storage that stores software, the software being configured to manage loan acquisition, the software when read and executed by a processor being configured to perform the steps of:
acquiring lending data from different loan/lender data suppliers;
scoring the lending data from each of the suppliers;
creating unique data elements that identify predicted risk tolerance and pricing alternatives for a plurality of lending institutions, wherein the unique data elements define two or more lenders with common attributes that are analytically scored;
matching qualifications of a consumer to one or more data elements; and
outputting an advisory that identifies at least one of the plurality of lending institutions matching the qualification of the consumer that identifies a best economical loan,
wherein the steps of acquiring, scoring, creating, matching and outputting are performed by a computer.

7. The computer program product claim 6, further configured to perform the step of creating a consumer borrowing capabilities that is based on credit scores of the consumer and information provided by the consumer for determining that the consumer meets lending parameters of at least one of the plurality of lending institutions.

8. The computer program product claim 6, further comprising establishing that at least two of the plurality of lenders have common attributes so that a data set having the data elements identify and encompass the at least two of the plurality of lenders.

9. The computer program product claim 6, further comprising acquiring lending data directly from independent lending institutions or their affiliates in addition to the independent loan/lender data suppliers and a National Credit Bureau to create the unique data elements.

10. A system for identifying perspective lenders and associated pricing comprising:
a server configured with decision engine that matches a consumer to a best lender of a plurality of lenders based on borrowing qualifications of the consumer;
a database configured to store risk tolerance and pricing alternatives for each of the plurality of lenders accessible by the server; and
a storage accessible by the server that stores consumer borrowing qualifications;
wherein the decision engine uses the risk tolerance and pricing alternatives of each lender to determine the best lender based on consumer borrowing qualifications.

11. The system of claim 10, wherein the server provides a website to interact with a consumer to acquire at least part of the consumer borrowing qualifications.

12. The system of claim 10, wherein the server is configured to provide an advisory to a consumer that indicates a best lender based on the borrowing qualifications of the consumer and the risk tolerance and pricing alternatives.

13. The system of claim 10, where the server cross tabulates and merges lending data from the plurality of lenders to produce a new data element that is matchable to pre-determined borrowing capabilities of the consumer.

14. The system of claim 10, where the data set encompasses at least two lenders of the plurality of lenders having a common attribute.
